(19) United States
(12) Patent Application Publication
(10) Pub. No.: US 2006/0031333 A1
(43) Pub. Date: Feb. 9, 2006

(54) Method to populate white list

(76) Inventor: Patrick J. O'Neill, Dana Point, CA (US)

Correspondence Address: Patrick Lilley, 17 Parma, Irvine, CA, 92602, US

(21) Appl. No.: 10/911,134

(22) Filed: Aug. 4, 2004

(51) Int. Cl. G06F 15/16

(52) U.S. Cl. 709/206

(57) ABSTRACT

The invention is selectively used by an Email Protection System that protects and email system from spam. This method is used if the Email Protection System classifies as spam an email connection or email message from an Email Sender. The invention is unlike other white list population methods or challenge/response systems in that it requires positive action by both the Email Sender and the Intended Email Recipient to add the Email Sender to a White List used by the Email Protection System. In accordance with the invention, the Email Protection System notifies the Email Sender of rejected email. The Email Sender uses a Request Form to request to be added to a White List. The Email Recipient confirms or denies the request. If the Email Recipient confirms, the Email Sender is added to the White List.

### FIELD OF THE INVENTION

The present invention relates to white lists used by email protection systems and, more particularly, to populating such white lists

### BACKGROUND OF THE INVENTION

Email protection systems, especially anti-spam (junk email) systems, often have a “white list” feature. A white list is a database of email sources explicitly allowed by the email protection system to send to a protected Receiving Email Server. Such white lists are comprised of records that may include email addresses, domain names, IP addresses, or IP address blocks. Most solutions require records to be manually added to the white list. This imposes an administrative burden on email administrators and end users. Because manual processes tend to take more than a few minutes to request and implement, email from legitimate sources can be blocked for longer than is desired.

Some email protection systems have automated white list processes. The current state of the art includes three general approaches to automatically populate a white list.

One method is to import or access a list of “contacts” maintained by end users or IT administrators in the organization that uses the anti-spam system. An example would be a Microsoft Outlook contact list maintained on the personal computer of an employee of ABC Company. The assumption is that email messages are legitimate if they are from sources who are listed in contact lists at ABC Company.

A second method used to automatically populate a white list is for the email protection system to examine outgoing email messages, extract recipient email addresses, and place those email addresses into the white list. The assumption is that the recipients of messages sent from within an organization are appropriate to allow to send email messages to people in that organization.

An alternate approach to automatically populating a white list is to use “challenge-response” schemes as exemplified in U.S. Pat. Nos. 6,393,465 and 6,112,227, which send a request or an email message back to the sender to test if the sending server and email address is valid. Such methods temporarily hold the sender's email message. If the original sender responds appropriately, their email message is allowed.

All of the three methods described above have significant drawbacks.

The first method described relies on existing contact lists. Unfortunately many email clients have a default setting that automatically adds sending email addresses to the contact list. If this setting is used, any spam message that gets through the email protection system will therefore have its sender added to the contact list. In turn the email protection system will import the new contact through the automated white list process. Also, many viruses have infected computers and sent emails from those systems to everyone in the contact lists on those computers. This is sometimes used by “spammers” as a method to send spam messages from computers owned by someone else. Computers used in this way are sometimes referred to as “zombies”. It would obviously be feasible for a spammer to initiate a virus that added contacts to a contact list instead of merely using contacts in that list. The contacts added could be sources of spam, thereby allowing the spammer to cause an email protection system to automatically add his sending email server to a white list.

The second method described, which is populating a white list from recipients of outgoing email messages, has drawbacks as well. Most email systems allow “vacation auto-responder” rules. These rules cause incoming email senders to be notified automatically that the email recipient is on vacation or otherwise unavailable. If an email protection system automatically adds outgoing email recipients to a white list, then a vacation auto-response will automatically respond to any spam message that enters the email system, and will thereby add the spam sources to the white list.

The third approach, a challenge-response system that does not require a white list, automatically validates that there was a “legitimate” response to a challenge. Usually the challenge is carefully constructed in such a way as to ensure a high probability that the response will be from a human being, in order to prevent spammers from automating responses to such challenges. Nevertheless, this is merely an escalating war between such systems and spammers, who employ considerable resources to work around such obstacles. Challenge-response systems are vulnerable because they only require human intervention on one side of the transaction: the sender's. They do not require permission from the receiving party, who ultimately should be deciding which senders are allowed. Therefore it continues to be difficult to create a sustainable challenge-response solution that cannot be circumvented by spammers. Challenge-response systems also do not populate white lists.

What's needed is a method that is as automated and streamlined as possible, even to the point of eliminating the need for technician or administrator involvement, while requiring human action from both sender and recipient. Human action from the recipient is particularly important, again because it should be the recipient's decision which senders are added to the white list. In such a way a sustainable automated white list solution is possible.

It is therefore an object of the invention to reduce the administrative burden, and otherwise increase the efficiency, of populating a white list.

It is another object of the invention to minimize the number of spam sources inadvertently added to a white list.

It is another object of the invention to minimize the effort for a legitimate but rejected email sender to be added to a white list, while presenting sufficient barriers to prevent spam sources from circumventing the automated white list process.

### SUMMARY OF THE INVENTION

The invention is selectively used by an Email Protection System that protects and email system from spam. This method is used if the Email Protection System classifies as spam an email connection or email message from an Email Sender. The invention is unlike other white list population methods or challenge/response systems in that it requires positive action by both the Email Sender and the Intended Email Recipient to add the Email Sender to a White List used by the Email Protection System. In accordance with the invention, the Email Protection System notifies the Email Sender of rejected email. The Email Sender uses a Request Form to request to be added to a White List. The Email Recipient confirms or denies the request. If the Email Recipient confirms, the Email Sender is added to the White List.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a process view of a method by which an email protection system may add an Email Sender to a white list.

For purposes of clarity and brevity, like elements and components will bear the same designations and numbering throughout the FIGURES.

### DESCRIPTION OF THE PREFERRED EMBODIMENT

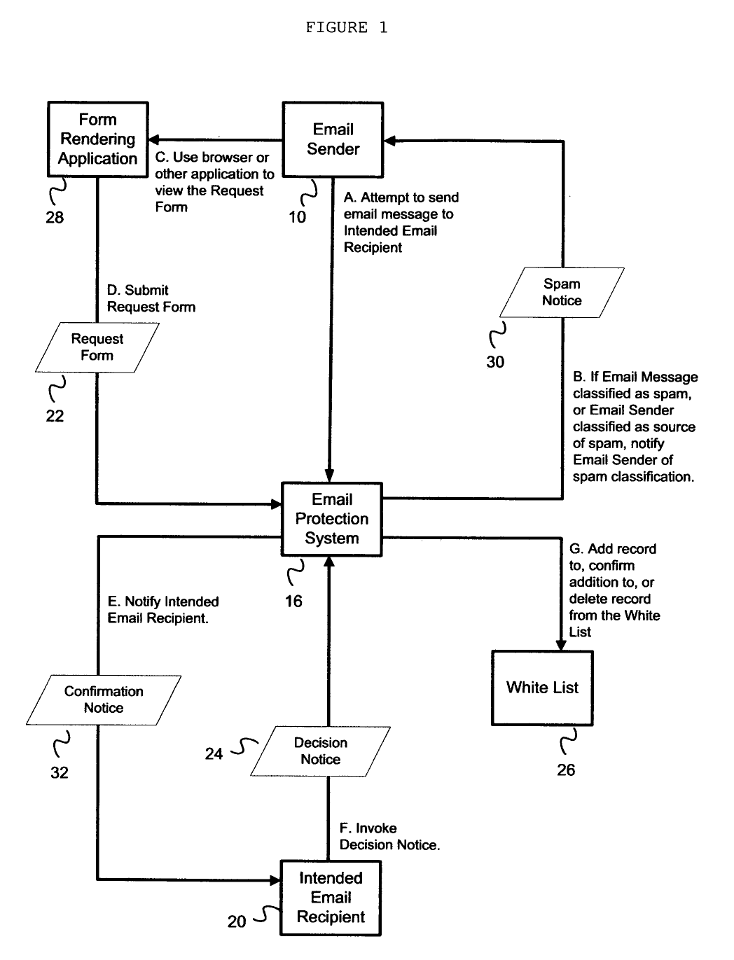

FIG. 1 is a flowchart view of a method by which an Email Protection System 16 may add an Email Sender 10 to a White List 26.

The Method to Populate White List 26 is used in an email system that comprises an Email Protection System 16. The Email Protection System 16 is intended to protect the email system from the burden of junk email (spam). The White List 26 Request and Confirmation Method is used by the Email Protection System 16.

The relevant use case is one in which a legitimate Email Sender 10 attempts to send an email message to an Intended Email Recipient 20, but the Email Protection System 16 erroneously classifies the email message as spam, or classifies the Email Sender 10 as a source of spam. Depending on the Email Protection System 16, the email message may not be accepted, may be accepted and deleted, or may be accepted and marked as spam. In all of these cases, it is selectively desirable to add the legitimate Email Sender 10 to a White List 26 used by the Email Protection System 16.

A White List 26 is a database of records identifying email servers or email senders that are explicitly allowed by the Email Protection System 16 to send to the protected email system of the Intended Email Recipient 20. A record in the White List 26 is comprised of an identifier (such as IP Address, email domain, or email address) of an allowed Email Sender 10. The White List 26 record is optionally comprised also of other information such as an identifier (such as email address) for a specific Intended Email Recipient 20, IP address of the Email Protection System 16, or a range of IP addresses to allow.

Unlike challenge/response acceptance methods or other automated methods used to populate a White List 26, the Request and Confirmation Method requires positive action by both the Email Sender 10 and the Intended Email Recipient 20. Only positive action by both parties is sufficient to add the Email Sender 10 to the White List 26 and confirm the addition.

The positive action by the Email Sender 10 comprises the use of a Request Form 22 after receiving a Spam Notice 30.

A Spam Notice 30 is comprised of a notification of spam classification, and information that enables the rejected Email Sender 10 to view and submit a Request Form 22. Optionally, the Request Form 22 may also be included in the Spam Notice 30. In the preferred embodiment, the Spam Notice 30 comprises an email message sent by the Email Protection System 16 to the Email Sender 10. This email message comprises a standard email message, along with the notification of spam classification. This email message also comprises instructions and URL string that enable the Email Sender 10 to use a Web browser to view and submit a Request Form 22. Other embodiments might replace the URL string with a software application attachment or other means to view and submit a Request Form 22 to the Email Protection System 16.

A Request Form 22 is comprised of a parameter that identifies the spam classification transaction in the Email Protection System 16. In addition, the form may optionally require the Email Sender 10 to enter additional information into data fields. Such information may comprise the email address of the Intended Email Recipient 20, information identifying the Email Sender 10, a whole or partial copy of the Email message, or other information according to the configuration of the Request Form 22. Also, the Request Form 22 may optionally comprise an anti-automation element, which is a means provides a high level of confidence that a human being is submitting the Request Form 22. The preferred embodiment of the Request Form 22 is a Web-based browser form. However, it should be apparent that the Request Form 22 may be embodied as a software application that renders and presents an interactive form. In any embodiment, the Email Sender 10 uses a Form Rendering Application 28 to submit the Request Form 22 to the Email Protection System 16.

The positive action by the Intended Email Recipient 20 comprises the activation of a Decision Notice 24 after receipt of a Confirmation Notice 32 from the Email Protection System 16 16.

A Confirmation Notice 32 is comprised of a parameter that identifies the spam classification transaction in the Email Protection System 16. The Confirmation Notice 32 also comprises information—obtained from the classification transaction—that identifies the Email Sender 10, such as email address or email domain. The Confirmation Notice 32 also comprises information that enables the Intended Email Recipient 20 to activate a Decision Notice 24. The Confirmation Notice 32 optionally comprises additional information submitted with the Request Form 22, such as further information identifying the Email Sender 10, a whole or partial copy of the Email message, or other information according to the configuration of the Request Form 22. In the preferred embodiment, the Confirmation Notice 32 comprises an email message sent by the Email Protection System 16 to the Intended Email Recipient 20. This email message comprises a standard email message, along with the notification of the request by the Email Sender 10. This email message also comprises instructions and URL string that enable the Intended Email Recipient 20 to activate a Decision Notice 24. Other embodiments replace the URL string with a software application attachment or other means to activate a Decision Notice 24.

Upon activation by the Intended Email Recipient 20, the Decision Notice 24 is sent to the Email Protection System 16. The Decision Notice 24 is comprised of the parameter that identifies the spam classification transaction in the Email Protection System 16. The Decision Notice 24 also comprises information indicating that the Intended Email Recipient 20 confirmed or denied the request of the Email Sender 10 to be added to the White List 26. The Decision Notice 24 optionally comprises additional information indicating that the Intended Email Recipient 20 wishes to add the Email Sender 10 to an optional black list.

A black list, which is not required by the Request and Confirmation Method, is a database of records identifying email servers or email senders that are explicitly disallowed by the Email Protection System 16 to send to the protected Recipient's Email Server.

Keeping in mind the above definitions, the Request and Confirmation Method uses the following process:

A. A legitimate Email Sender 10 attempts to send an email message to the Intended Email Recipient 20, where the Intended Email Recipient's email system is protected by the Email Protection System 16.

B. The Email Protection System 16 erroneously classifies the email message as spam, or classifies the Email Sender 10—or his/her email system—as a source of spam. The Email Protection System 16 then sends a Spam Notice 30 to the Email Sender 10.

C. The Email Sender 10 views the Request Form 22 using an appropriate Form Rendering Application 28, filling in any required data fields.

D. The Email Sender 10 submits the Request Form 22, which is sent to the Email Protection System 16.

E. The Email Protection System 16 sends a Confirmation Notice 32 to the Intended Email Recipient 20. In the preferred embodiment, the Email Protection System 16 does not yet make any modification to the White List 26. In another embodiment, the Email Protection System 16 adds the Email Sender 10 to the White List 26 on a provisional basis. Both embodiments are consistent with the Request and Confirmation Method.

F. The Intended Email Recipient 20 selectively invokes the Decision Notice 24 associated with the Confirmation Notice 32.

G. The Email Protection System 16 takes the action appropriate to the Decision Notice 24. In the preferred embodiment, if the Intended Email Recipient 20 has confirmed the request by the Email Sender 10, the Email Protection System 16 adds the Email Sender 10 to the White List 26. Again in the preferred embodiment, if the Intended Email Recipient 20 has denied the request of the Email Sender 10, the Email Protection System 16 does not add the Email Sender 10 to the White List 26. In another embodiment, where the Email Protection System 16 had already added the Email Sender 10 to the White List 26 on a provisional basis, the Email Protection System 16 deletes the Email Sender 10 from the White List 26. In this alternate embodiment, if the Intended Email Recipient 20 has confirmed the request of the Email Sender 10, the Email Protection System 16 does not delete the Email Sender 10 from the White List 26.

From this point forward, the Email Protection System 16 uses the White List 26 in whatever manner it uses to explicitly allow email messages from the Email Sender 10.

The above describes the overall process by which an Email Protection System 16 uses the Request and Confirmation Method to add an Email Sender 10 to a White List 26.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A method to populate white list for enabling an email protection system to populate a white list comprising:
means for protecting an email network from junk email;
means for notifying an email sender that an email message was classified as spam;
means for enabling a rejected email sender to request to be added to a white list;
means for notifying an intended email recipient of a request to add an email sender to a white list;
means for selectively directing an email protection system to accept or revoke a request by an email sender to be added to a white list; and
means for listing email senders or email sources explicitly allowed to send email to a recipient's email system, virtually connected to said means for protecting an email network from junk email.

2. The method to populate white list in accordance with claim 1, wherein said means for protecting an email network from junk email comprises an email protection system.

3. The method to populate white list in accordance with claim 1, wherein said means for notifying an email sender that an email message was classified as spam comprises an electronic spam notice.

4. The method to populate white list in accordance with claim 1, wherein said means for enabling a rejected email sender to request to be added to a white list comprises an electronic request form.

5. The method to populate white list in accordance with claim 1, wherein said means for notifying an intended email recipient of a request to add an email sender to a white list comprises an electronic confirmation notice.

6. The method to populate white list in accordance with claim 1, wherein said means for selectively directing an email protection system to accept or revoke a request by an email sender to be added to a white list comprises an electronic decision notice.

7. The method to populate white list in accordance with claim 1, wherein said means for listing email senders or email sources explicitly allowed to send email to a recipient's email system comprises a white list.

8. A method to populate white list for enabling an email protection system to populate a white list comprising:
an email protection system, for protecting an email network from junk email;
an electronic spam notice, for notifying an email sender that an email message was classified as spam;
an electronic request form, for enabling a rejected email sender to request to be added to a white list;
an electronic confirmation notice, for notifying an intended email recipient of a request to add an email sender to a white list;
an electronic decision notice, for selectively directing an email protection system to accept or revoke a request by an email sender to be added to a white list; and
a white list, for listing email senders or email sources explicitly allowed to send email to a recipient's email system, virtually connected to said Email Protection System.
